(19) United States
(12) Patent Application Publication
(10) Pub. No.: US 2009/0078920 A1
(43) Pub. Date: Mar. 26, 2009

(54) Rigid Telescopic Mechanism

(76) Inventor: Aristides Gogoussis, Thessaloniki (GR)

Correspondence Address: Aristides Gogoussis, 39 Filippou Str., Thessaloniki, 54631, GR

(21) Appl. No.: 11/922,303

(22) PCT Filed: Jun. 27, 2006
(86) PCT No.: PCT/GR2006/000031

§ 371 Date: Dec. 17, 2007

(30) Foreign Application Priority Data
Jul. 1, 2005 (GR) 20050100340

(51) Int. Cl. B66F 3/22

(52) U.S. Cl. 254/122

(57) ABSTRACT

Rigid telescopic mechanism comprised of rigid members and revolute joints in a geometric arrangement which allows for the longitudinal expansion of the mechanism which is characterized by the attribute that the end-member as well as some intermediate members are moving straight and parallel to themselves as well as by the property of the whole structure (a) not to shrink across the transverse direction while the mechanism extends and (b) to possess members which during the extension do not tend to align along the longitudinal axis of the expansion but maintain, instead, diagonal-oblique directions, thus participating in the raising of resistance against transverse and bending loads, consequently reducing the compressive and tensile stresses in the elements of the mechanism (members and joints). Mechanisms of this kind are employed (a) for approaching remote points in space by mechanical means, with the objective of transporting objects, or bearing loads, or moving tools between a base and a remote location whose position may be stationary or variable, (b) for exerting forces and moments at various points located at various distances away from the mechanism's base, (c) in robotic arms with links of varying length, (d) in outer space applications.

The invention is referred to an expandable mechanism of the telescopic type, which displays high endurance to mechanical loads.

Expandable telescopic mechanisms of variable span are utilized for approaching by mechanical means remote points in space, aiming at the transport or carrying of objects or loads (e.g. elevating devices, variable-length bridges or stadium-roofs, cranes etc.) or tools, from a base to a remote point whose position may be stationary or variable. Moreover, telescopic mechanisms are employed for exerting forces and torques at various carriers located at various distances away from their grounded end. Combinations of expandable mechanisms may also constitute variable length links of robotic arms for robotic applications (e.g. trajectory control of the end-effector or exertion of forces/torques to various mediums or measurement of spatial coordinates by optical or haptic sensors properly adapted etc.). Furthermore, expandable telescopic mechanisms are implemented in outer space applications where mechanisms spanning long distances and having a low total mass are needed (so that not much energy is required during their operation and in order not to impede the launching while the gravitational field is still intense).

Expandable telescopic mechanisms consist of a repeated implementation of a basic “cell” which is capable of contraction and extension. The connection of such cells to each other enhances the capability for a further increase of the reach of the total mechanism. The core of a basic cell may be taken to be of the diagonal-cross type (i.e. in the lazy-tongs/scissors-like manner). In such an arrangement two equal rods are connected in their middle through a rotational joint (forming a pivot) thus resulting in the shape of the letter x. Next, a second identically-shaped cell is connected to the endpoints of the first, by articulate joints also, thus forming a double group xx. In this manner many other cells may be appended longitudinally, contributing to a multiple group of x's i.e. xxxx.

As a telescopic mechanism extends, its length increases. Given that the lengthening is due to the modification of the relative positions of the elementary constituents of the mechanism (which are simple rigid members connected to each other by articulate joints) the “width” of the mechanism changes also. For instance a contracted telescopic mechanism of the diagonal-cross type [symbol] , when in semi-extension has the [symbol] shape, while in further expansion its links mutually align even more and the mechanism tends to assume the straight line-segment form [symbol] . Since the width shrinks as the mechanism extends, the mechanical strength of the mechanism to external loads also drops. This is due to the well known fact that when bending-moments or lateral (shearing) loadings arise which strain slim elements or a slim structure, their effect is intensified in inverse proportion with the width.

The description above regarding the case of transverse loads, implies the appearance of high forces and stresses to the elementary members of the mechanism. These forces are at some places tensile and at some other compressive. As a matter of fact the thinner the mechanism the higher the stresses which develop throughout its members. In any case, those forces on the one hand strain the joints and on the other hand they contribute to deformation (due to buckling). The straining of the joints owing to the magnitude of forces cannot be avoided because it is clearly a matter of geometry. What can be done is the reduction of the internal stresses of the members by increasing their cross-section, in order to avoid plastic deformation or fracture. Nevertheless, although this solution may limit the degree of deformation, it is not satisfactory because the mass of the mechanism is also increased and thus its inertia, with the consequence that: (a) the mechanism accelerates and decelerates with greater effort for given force or torque limits of the guiding actuator, and (b) more power is required for rapid operation. Furthermore, in case of operation within a gravitational field, the forces and torques due to the increased weight contribute to further straining of the joints as well to further global deformation. To avoid excessive straining of the joints and also to avoid significant deformation of a telescopic mechanism it is then desirable to ensure that it does not become thinner with expansion and that it possesses oblique members not strained by bending moments as it unfolds. This can be achieved by determining the appropriate geometry of the basic “cell” and by the proper mutual connection of the cells.

In accordance with the invention the core of the basic cell consists of seven rigid members connected to each other with revolute joints. Six of these members are connected to each other in a formation of a simply closed planar polygon whereby the vertices constitute revolute joints.

The first of the six members is considered grounded and as a result its two revolute joints are fixed with respect to the reference frame. All the remaining joints are not fixed. The numbering of the members is considered according to their succession sequence with respect to their linking, starting with the first (grounded) member. A seventh member is connected to the mobile joint of the second member and to the mobile joint of the sixth member, namely the mobile joints of the two members adjacent to the grounded member are no longer independent but they constitute joints of the seventh member. The length of each member is selected so that when the fourth member moves parallel to the grounded one, its joints move straight. In particular, every point of the fourth member moves perpendicularly to the grounded member. Consequently, for development of the mechanism in a straight line manner, a condition of self-parallelism of the fourth member during its motion is imposed.

The conditional achievement of straight line motion guarantees that: the mechanical “complement” of the cell's core which will be used to satisfy the imposed condition (of self-parallelism)—thus completing the basic cell—will necessarily participate in the resistance against transverse forces. This is so because if the complement did not participate it could have been omitted. However, in that case the motion of the fourth member would not be straight and perpendicular to the grounded member, a fact which implies that the mechanism would have yielded transversely. Indeed, in that case the cell would not possess one but two degrees of freedom instead.

The core and its complement therefore form the basic cell. Following, other cells of similar configuration may be linked to each other to compose the telescopic expandable mechanism. The connection is implemented in a manner such that the resulting system is not over-determined with respect to the degrees of freedom, namely there must always be one only degree of freedom (which allows for the longitudinal variation of the mechanism). Moreover, the connection of two successive cells is accomplished in a way that the extension of the second cell is determined through the parallelism condition, not conversely; because, if the extension of the next cell is accomplished in an alternative way which does not enforce the satisfaction of the parallelism condition, but rather parallelism emanates independently, then the extra members involved in realizing the parallelism condition would not participate in the resistance to transverse (perpendicular) loads. That however, would cancel the advantage of the invention whereby all the members are involved in the bearing of the external transverse forces and moments.

The invention is described below with reference to the accompanying figures.

FIG. 1 depicts the core of the basic cell of the mechanism.

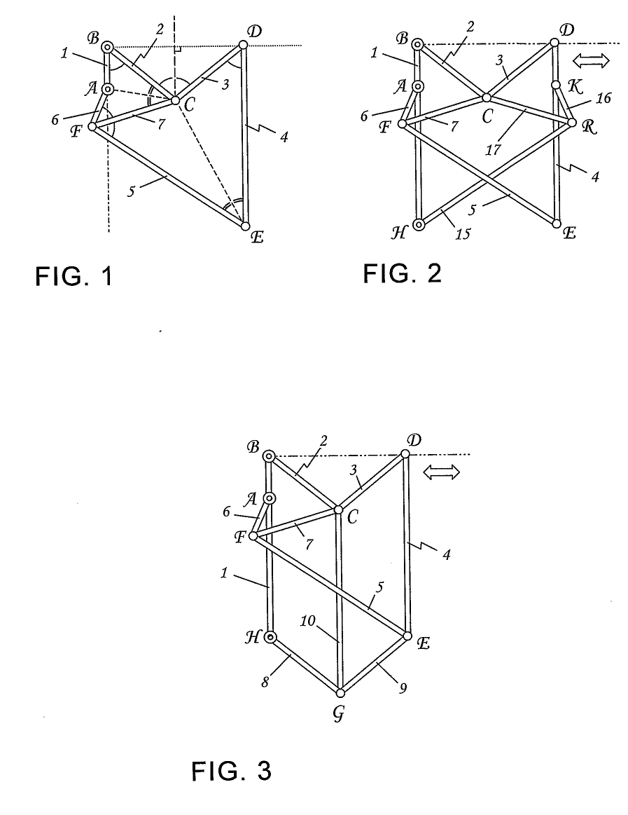

FIG. 2 depicts a symmetrical version of the basic cell.

FIG. 3 depicts an alternative asymmetric version of the second basic cell.

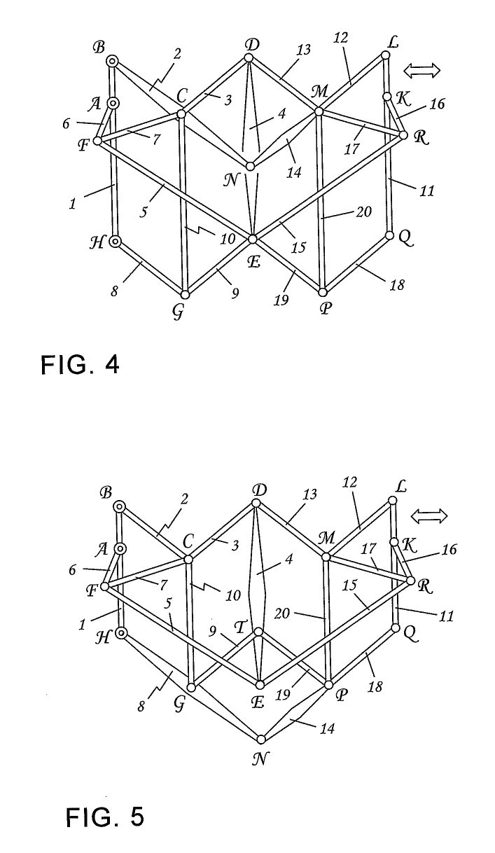

FIGS. 4, 5 and 6 demonstrate various ways of connecting successive cells.

FIG. 7 depicts a version with cells of different size.

In FIG. 1 the various members are indexed with natural numbers while the joints are referenced by capital letters. The fixed joints are denoted by two concentric circles while the mobile ones by a single circle. Alternatively, the referencing of various members may be accomplished by the corresponding joint pairs (e.g. member 3 may be denoted by CD). The first member is considered as the reference frame and the motion of the mechanism is considered in reference to it. The first and the sixth member are equal lengthwise. The second, third, and seventh member are also equal in length to each other but twice as long as the first member. Members 4 and 5 are equal to each other lengthwise, twice as long as the second member. Namely there are three lengths in total, whereby the relation of the lengths is 1:2:4.

At this point is will be shown how the relation of lengths is derived when the fourth member is parallel to the first and joint D lies on a line perpendicular to the first member passing through B. Indeed, angle FCD=FCB+BCD (1). Angle FCB=2FCA (2) due to the equality of triangles FCA and BCA (they have all sides equal). Since triangle BCD is equilateral, angle BCD=2ABC (3). By substituting (2) and (3) into (1) we obtain FCD=2(FCA+ABC) (4). Because DE//BA, angle BCD=2CDE (5). Thus from (3) and (5) it follows that angle ABC=CDE (6). Yet, angle FCD is the exterior angle of triangles FCE and DCE and therefore FCD=FED+EFC+EDC (7). However, due to the equality of triangles FCE and DCE (all sides are equal) equation (7) becomes: FCD=2(CDE+FEC) (8). Substitution of CDE from (6) into (8) yields FCD=2(ABC+FEC) (9).

Comparison of (4) and (9) leads to the conclusion that angles FEC and FCA are equal. Also, angle AFC=ABC (due to the equality of triangles FCA and BCA). From (6) and the equality of angles CDE=CFE (since triangles CDE and CFE are equal) it is deduced that triangles FCA and FEC are similar because they have two angles equal. Therefore |AF|:|FC|=|CF|:|FE| (10), whereby |XY| denotes the length of line segment XY. Rearrangement of (10) yields |AF|·|FE|=|CF|² (11). If we choose |AF|=1 and |GF|=2 then (11) yields |FE|=4. Thus the selection of length proportions 1:2:4 mentioned previously is verified. Examination of (11) indicates that there is a possibility for unlimited choices for the lengths of the members in relation to each other as long as equality (11) holds. Considerations of space and dynamics may determine additional choices of the respective lengths accordingly.

In FIG. 2 the symmetrical version of the basic cell ensures simultaneously parallelism and straight line motion, in the sense that as the mechanism develops, D traces out a straight line passing through B while being perpendicular to member 1.

In FIG. 3 a symmetrical version of the basic cell is depicted. The parallelism condition is ensured by parallelograms BCGH and CDEK.

In FIG. 4 a way of connecting two basic cells is indicated. The transmission of motion from the first to the second cell is accomplished by means of members 2 and 14. Members 2, 4 and 14 have been intentionally widened at the middle to prevent confusion in understanding the issues that are analyzed subsequently. It is clarified that members 2, 3, 7 and 10 share joint C while members 2 and 14 are jointly pivoted at N. Joint N is not a joint of member 4. Members 2 and 14 with the aid of parallelogram NCDM determine the motion of joint M rendering it a mirror image of joint C with respect to member 4. Members 15, 16 and 17 ensure the straight line motion of joint L. If members 14 and 12 were united, thus forming a single member, then the motion of L would be completely determined and members 15, 16 and 17 should be omitted due to kinematic over-determination. Then the mechanism would be of the diagonal-cross type with all the shortcomings that have already been mentioned. With the connection mode of FIG. 4 all members participate in bearing the transverse forces and moments.

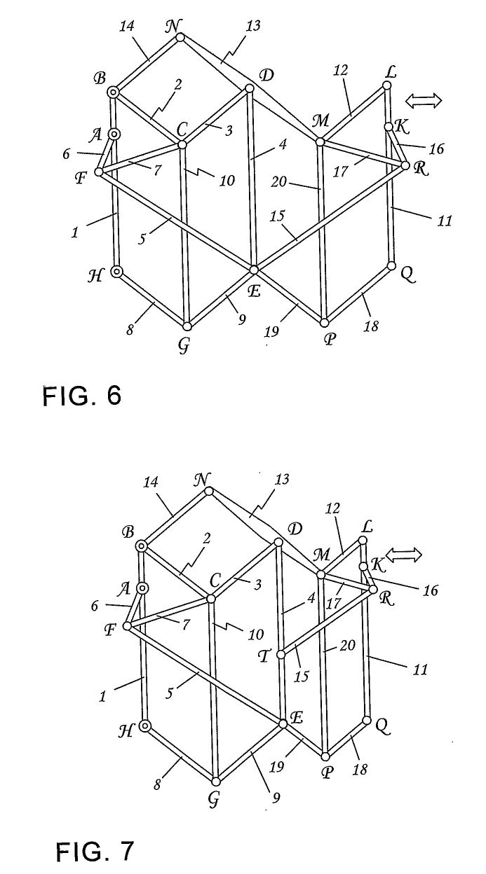

FIGS. 5 and 6 illustrate alternative possibilities of connecting neighboring cells. To facilitate the comprehension some members have been widened at the middle. In particular, in FIG. 5 joint T is common to members 4, 9, and 19. The transmission of motion from the first cell to the second is accomplished through member 8 (whose length is twice as long as that of member 2 which belongs to the basic cell of FIG. 1) which is co-pivoted with member 14 at joint P.

In FIG. 6 the transmission of motion to the second cell is accomplished through member 13 (having double the length of member 2) which is co-pivoted with member 14 at joint P. The connection of additional cells may be implemented by numerous other variations of the basic cell of FIG. 1 which are based on horizontal or vertical catoptrical versions of the configuration of FIG. 1 combined with parallelograms of the type displayed in FIG. 3.

FIG. 7 demonstrates a version of connecting adjacent cells of different size. The configuration of this combination is similar to that of FIG. 6. Yet, members 12, 13, 15, 16, 17, 18, 19 of the second cell are smaller than their counterparts of the first cell (i.e. 2, 3, 5, 6, 7, 8, 9) with length a sub-multiple of them (having the same coefficient of proportionality). Member 13 has been elongated as much as required for it to be co-pivoted with member 12 at joint M. This version as well as its variants according to the hints that accompany the comments of FIGS. 5 and 6, may contribute to the generation of various multi-cellular telescopic expandable mechanisms.

1. Rigid telescopic mechanism based on a configuration comprising of rigid members and revolute joints, which is characterized by a core and an appendage, which jointly form a basic cell of one degree of freedom whereby the core consists of seven rigid members connected to each other with revolute joints (FIG. 1) such that six of these members 1, 2, 3, 4, 5, 6 are connected to each other in an arrangement of a planar simply closed polygon having the first (1) of the six members grounded and the seventh member (7) connected to the mobile joint of the second member (2) and of the sixth member (6), so that the whole compound unit possesses two degrees of freedom, and with lengths of the members selected to validate the condition that when the fourth member (4) moves parallel to the grounded one, its joints move in a straight line (something which is ensured when the relation κμ=λ², is valid, where μ denotes the length of the first (1) and sixth (6) member, λ is the length of the second (2), the third (3) and the seventh (7) member, and κ is the length of the fourth (4) and fifth (5) member), whereas the appendage—which when connected to the core removes one degree of freedom from it while at the same time satisfying the aforementioned condition—consists of three additional members 15, 16, 17 which are the symmetric counterparts of members 5, 6, 7 with member (4) as the axis of symmetry, thus completing the basic cell (FIG. 2) which finally possesses one degree of freedom.

2. Rigid telescopic mechanism according to claim 1, which is characterized by the fact that the completion of the core (FIG. 1) is accomplished through an appendage (FIG. 3) of three members (8, 9, 10) arranged such that members 2 and 8 are equal and parallel to each other, members 3 and 9 are equal and parallel to each other, and member 10 is equal and parallel to members 1 and 4, thus forming a basic cell of one degree of freedom.

3. Rigid telescopic mechanism according to claim 2, which is characterized by the fact that the connection of the next basic cell with the first is implemented (FIG. 4) via the lengthwise doubling of member 2 and through its co-pivoting with member 14 which transfers the motion for extension or contraction to the second basic cell (which is certainly not grounded) consisting of members 11, 12, 13, 14, 15, 16, 17, 18, 19, 20 in a configuration which is symmetrical with respect to the corresponding members 1, 2, 3, 4, 5, 6, 7, 8, 9, 10 and is having as a symmetry axis that of member 4.

4. Rigid telescopic mechanism according to claim 2, which is characterized by the fact that the connection of the next basic cell with the first is implemented (FIG. 5) via the lengthwise doubling of member 8 and through its co-pivoting with member 14 which transfers the motion for extension or contraction to the second basic cell consisting of members 11, 12, 13, 14, 15, 16, 17, 18, 19, 20 in a configuration which is symmetrical with respect to the corresponding members 1, 2, 3, 4, 5, 6, 7, 8, 9, 10 and is having as a symmetry axis that of member 4, whereby members 9, 19 and 4 are co-pivoted at a joint different from that of members 5, 15 and 4.

5. Rigid telescopic mechanism according to claim 2, which is characterized by the fact that the connection of the next basic cell with the first is implemented (FIG. 6) via the lengthwise doubling of member 13 and through its co-pivoting with member 14, which is in turn co-pivoted with members 1 and 2, whereby member 13 transfers the motion of either extension or contraction to the second basic cell which consists of members 11, 12, 13, 14, 15, 16, 17, 18, 19, 20, resulting in an integrated arrangement which is symmetrical, with axis of symmetry that of member 4.

6. Rigid telescopic mechanism according to claim 5, which is characterized by the fact that (FIG. 7) members 12, 13, 15, 16, 17, 18, 19 of the second cell may be different from their counterparts of the first cell, namely 2, 3, 5, 6, 7, 8, 9, with length a sub-multiple or multiple or equal to them (with the same coefficient of proportionality) whereby member 13 has been elongated as much as required for its co-pivoting with member 12 at joint M, and subsequently member 13 transfers the motion of extension or contraction to the second basic cell consisting of members 11, 12, 13, 14, 15, 17, 18, 20, resulting in a total configuration topologically symmetrical and geometrically similar, with axis of symmetry that of member 4.

7. Rigid telescopic mechanism according to claim 3, which is characterized by the fact that the members of the second cell are of the same configuration but, if necessary, of different lengths in proportion to a magnification (or reduction or unitary) factor so that the straight-line and self-parallel motion of member 11 is derived.

8. Rigid telescopic mechanism according to claim 4, which is characterized by the fact that the members of the second cell are of the same configuration but, if necessary, of different lengths in proportion to a magnification (or reduction or unitary) factor so that the straight-line and self-parallel motion of member 11 is accomplished.

9. Rigid telescopic mechanism according to any of the foregoing claims 1 through 8 or combination thereof, which is characterized by successive connections of basic cells or variations of like configurations for generating multi-cellular telescopic mechanisms.
